(19) United States
(12) Patent Application Publication
(10) Pub. No.: US 2010/0204917 A1
(43) Pub. Date: Aug. 12, 2010

(54) Map data distribution server and method for processing map data

(75) Inventor: Atsushi Tanabe, Anjo-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/591,128

(22) Filed: Nov. 10, 2009

(30) Foreign Application Priority Data
Feb. 6, 2009 (JP) 2009-25807

(51) Int. Cl. G01C 21/36

(52) U.S. Cl. 701/209

(57) ABSTRACT

A reading unit reads position information on a home point of a user, position information on a registered point associated with the user or a user's device and stored in a storage medium, first map data same as map data used by the user in version, and second map data newer than the first map data in version. A route calculating unit calculates a new route from the home point to the registered point based on the second map data. A new additional road extracting unit extracts a new additional road, which is specified in the second map data and is not specified in the first map data, from the new route. A transmitting unit extracts road data of the extracted new additional road from the second map data and transmits the extracted road data to be used by the user's device.

### CROSS REFERENCE TO RELATED APPLICATIONS

This application is based on and incorporates herein by reference Japanese Patent Application No. 2009-25807 filed on Feb. 6, 2009.

### FIELD OF THE INVENTION

The present invention relates to a map data distribution server. The present invention further relates to a method for processing map data to be distributed to a user.

### BACKGROUND OF THE INVENTION

For example, JP-A-2007-147382 discloses an art for distributing map data to an in-vehicle device or the like. Further, JP-A-2006-162270 discloses an art for limiting a range of map data to be distributed based on a point registered by a user who is to receive the map data distributed to the user. However, in the arts of JP-A-2007-147382 and JP-A-2006-162270, map data in a range, which need not be updated, may be distributed to a user. In view of the foregoing and other problems, it is an object of the present invention to produce a map data distribution server capable of reducing possibility of distributing a portion of map data, which need not be updated, when distributing the map data. It is another object of the present invention to produce a method for processing map data to be distributed to a user.

### SUMMARY OF THE INVENTION

The present invention addresses the above disadvantage. According to one aspect of the present invention, a map data distribution server for distributing map data, the map data distribution server comprises a communication interface configured to distribute map data. The map data distribution server further comprises a storage medium. The map data distribution server further comprises a control unit. The control unit includes a reading unit configured to read from the storage medium that:
i) position information on a home point registered as a point of a home of a user who is to receive distributed map data;
ii) position information on a registered point associated with the user or a user's device used by the user and stored in the storage medium;
iii) first map data same as map data used by the user in version; and
iv) second map data newer than the first map data in version.

The control unit includes a route calculating unit configured to calculate a new route from the home point to the registered point based on the second map data. The control unit further includes a new additional road extracting unit configured to extract a new additional road, which is specified in the second map data and is not specified in the first map data, from the new route. The control unit further includes a transmitting unit configured to extract road data of the extracted new additional road from the second map data and transmit the extracted road data to be used by the user's device.

According to another aspect of the present invention, a method for processing map data to be distributed to a user, the method comprises reading from a storage medium in a map data distribution server that:
i) position information on a home point registered as a point of a home of the user;
ii) position information on a registered point associated with the user or a user's device;
iii) first map data same as map data used by the user in version; and
iv) second map data newer than the first map data in version.

The method further comprises calculating a new route from the home point to the registered point based on the second map data. The method further comprises first extracting a new additional road, which is specified in the second map data and is not specified in the first map data, from the calculated new route. The method further comprises second extracting road data of the extracted new additional road from the second map data.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a map data distribution system;

FIG. 2 is a sequence chart showing a procedure of a map data distribution server of the data distribution system and a navigation device for a vehicle;

FIG. 3 is a flow chart showing extraction and distribution of updating data performed by the map data distribution server;

FIG. 4 is a schematic view showing a guidance route calculated using a previous version of map data; and

FIG. 5 is a schematic view showing a guidance route calculated using a new version of map data.

### DETAILED DESCRIPTION OF PREFERRED EMBODIMENTS

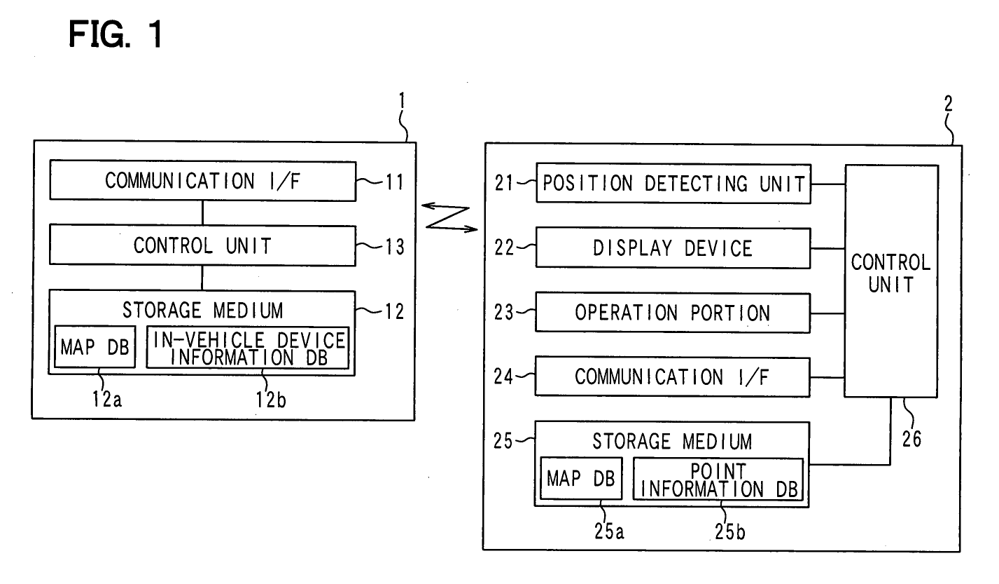

As shown in FIG. 1, a map data distribution system according to the present embodiment includes a map data distribution server 1 and an in-vehicle navigation device 2. The in-vehicle navigation device 2 is an example of a user's unit.

The map data distribution server 1 stores map data and distributes a new version of map data to an in-vehicle device such as the in-vehicle navigation device 2 when obtaining a new version of map data.

The in-vehicle navigation device 2 is mounted in a vehicle. The in-vehicle navigation device 2 is configured to calculate an optimal guidance route to a destination, which is set by a user such as a driver, and configured to perform audio assist and visual assist of the calculated guidance route. The in-vehicle navigation device 2 stores map data. The in-vehicle navigation device 2 uses map data as needed when calculating a guidance route and performing a guidance operation. The in-vehicle navigation device 2 updates stored map data to distributed new map data when receiving a new version of map data distributed from the map data distribution server 1.

In the present embodiment, the map data distribution server 1 is connected to a wide area network such as the Internet. Further, the map data distribution server 1 is configured to communicate with the in-vehicle navigation device 2 via a base transceiver station on the wide area network. The base transceiver station is, for example, a base station of cellular-phone communication or a base station of wireless LAN.

Hereafter, structures of the map data distribution server 1 and the in-vehicle navigation device 2 will be described in detail. As shown in FIG. 1, the map data distribution server 1 includes a communication interface 11, a storage medium 12, and a control unit 13.

The communication interface 11 is a generally-known interface for distribution of map data and configured to transmit and receive map data via a wide area network.

The storage medium 12 is a nonvolatile storage medium, such as a hard disk and a silicon disc, and configured to store a program executed by the control unit 13 and various data. For example, the storage medium 12 stores a map database (map DB) 12a and an in-vehicle device information database (in-vehicle device information DB) 12b.

The map DB 12a includes multiple versions of map data. It is noted that a road, a geographical feature, and a facility change as time passes. Therefore, new map data is successively created so as to follow change in a road, a geographical feature, and a facility. A version of newly created map data is newer than previous version of map data. Map data includes information on a version of the map data.

Each map data includes road data and facility data. Road data specifies arrangement and structure of a road. Road data includes various information such as position information on a link, classification information on a link, position information on a node, classification information on a node, and a connection between a node and a link. Facility data includes multiple records, which respectively correspond to facilities. Each of the multiple records includes various information such as a name, a location, an address (land lot number), a telephone number, and a facility classification of a target facility.

The in-vehicle device information DB 12b includes information on a user, who receives distributed map data. The information on a user is associated with each user. The information (user's information) of a user includes identification information on a user, which is related to a user's name, a user's ID, a user's home, and a registered point other than a home. Instead of user's identification information, the in-vehicle device information DB 12b may store identification information on the in-vehicle navigation device 2, which is owned and used by a user.

Information on a user's home includes an address of the user's home, a telephone number of the user's home, a position information on the user's home, and the like. Information on registered point other than a user's home includes an address of the registered point, a telephone number of the registered point, a position information on the registered point, and the like. The registered point other than a user's home may be a location such as a restaurant, a workplace, and a station, which a user frequently visits. Multiple registered points may be stored for one user.

The control unit 13 includes a CPU and the like. The control unit 13 is configured to execute a program read from the storage medium 12, configured to read information from the storage medium 12 when executing the program, configured to store information in the storage-medium 12, and configured to communicate with the communication interface 11, as needed. An operation of the control unit 13 will be described later in detail.

The in-vehicle navigation device 2 includes a position detecting unit 21, a display device 22, an operation portion 23, a communication interface 24, a storage medium 25, and a control unit 26.

The position detecting unit 21 includes various sensors such as a vehicle speed sensor and a GPS receiver. The position detecting unit 21 generates information for identifying a current position of a vehicle, a direction of a vehicle, and speed of a vehicle, based on the various sensors. The position detecting unit 21 outputs the information to the control unit 26. The display device 22 displays a picture and outputs voice according to a control operation of the control unit 26. The operation portion 23 accepts a user's operation and outputs a signal to a control circuit 17 based on the accepted user's operation.

The communication interface 24 is a wireless communication device configured to connect with a base station of wireless communications for communicating with the map data distribution server 1 via the base station and the wide area network.

The storage medium 25 is a nonvolatile storage medium, such as a hard disk and a silicon disc, and configured to store a program executed by the control unit 26.

The storage medium 25 stores data such as a map DB 25a and a point information DB 25b. The map DB 25a includes a single version of map data. The point information DB 25b is configured to store information such as a point relevant to a user of the vehicle, which has the in-vehicle navigation device 2. Specifically, the point information DB 25b is configured to store information such as identification information on a user, which is related to a user's name, a user's ID, a user's home, and a registered point other than a home. Instead of user's identification information, identification information on the in-vehicle navigation device 2 may be stored.

The control unit 26 includes a CPU and the like. The control unit 13 is configured to execute a program read from the storage medium 25, read information from the storage medium 25 when executing the program, and store information in the storage-medium 25. The control unit 13 is further configured to obtain a signal from the position detecting unit 21 and the operation portion 23, display information on the display device 22 as needed. The control unit 13 is further configured to communicate with the map data distribution server 1 via the communication interface 24, as needed.

For example, in response to input of a destination by a user using the control unit 13, the control unit 26 extracts the destination from map data. The control unit 26 further calculates an optimal guidance route from a current position specified by the position detecting unit 21 to the destination based on the map data, and performs visual assist and/or audio assist, such as a right turn and a left turn, along the calculated guidance route.

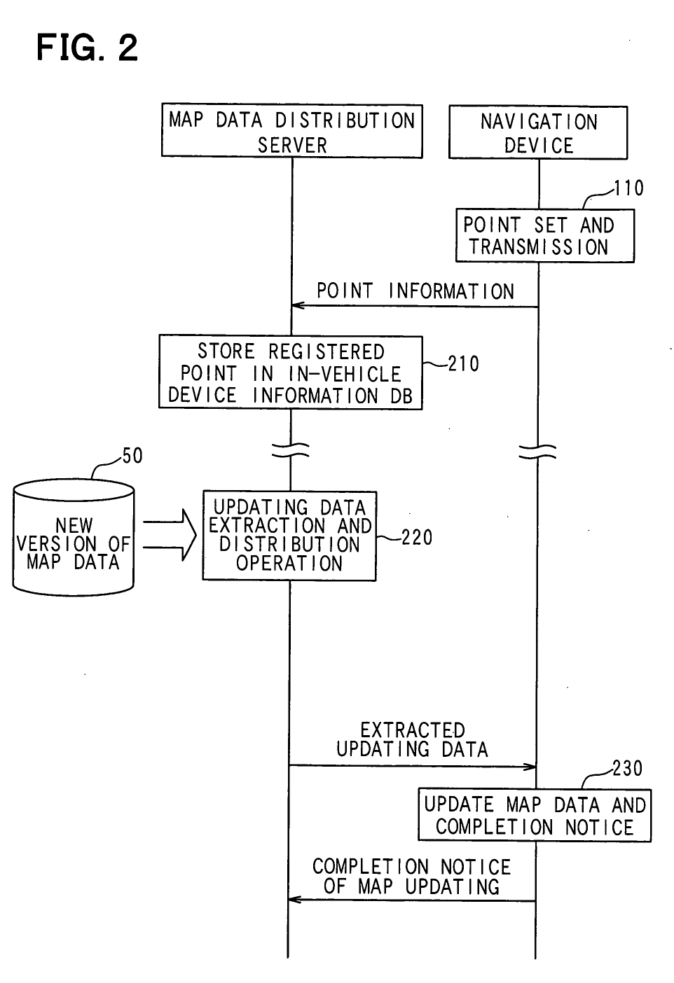

Hereafter, an operation for map distribution of the map data distribution server 1 and the in-vehicle navigation device 2 will be described in detail. As shown in the sequence chart of FIG. 2, at step 110, the in-vehicle navigation device 2 first performs point set and transmission. Specifically, the control unit 26 causes the display device 22 to display an interactive menu panel. Subsequently, a user specifies one facility by operating the control unit 13 in accordance with an instruction on the menu panel. The facility may be specified by inputting a name of the facility, an address, a telephone number, a position coordinate, and the like. The control unit 26 reads information on the facility specified in this way from the facility data of the map DB 25a. The control unit 26 further stores the read information as information on an additional registered point or a changed home point in the point information DB 25b. It is determined whether the read information is registered as an additional registered point or a home point based on a user's selection.

The control unit 26 transmits point information on the stored registered point or the stored home point to the map data distribution server 1 via the communication interface 24, when the registered point or the home point is newly stored in this way. The transmitted point information includes information on the stored point, such as a name, an address, a telephone number, and position information. In addition, the transmitted point information includes a version of map data currently stored in the map DB 25a, identification information on a user or identification information on the in-vehicle navigation device 2 stored in the point information DB 25b, and identification information for distinguishing whether the point information to be transmitted is the home point or another registered point. The transmitted point information does not include information on points other than the point newly stored in the in-vehicle navigation device 2. Therefore, information on a point transmitted in the past is not transmitted again.

It is noted that communication with the map data distribution server 1 may be impossible in dependence upon a wireless communication environment. When communication with the map data distribution server 1 is impossible, the storage medium 25 may hold data to be transmitted until communication with the map data distribution server 1 is established, and the control unit 26 may transmit data when communication is established.

When the control unit 13 of the map data distribution server 1 receives point information and the like transmitted via the communication interface 11 in this manner, the processing proceeds to step 210. At step 210, the control unit 13 associates the point information and the like with identification information on a user or identification information on the in-vehicle navigation device 2 as a sender based on received information. Thus, the control unit 13 stores received point information in the in-vehicle device information DB 12b.

The processings of steps 110 and 210 are executed in response to instruction of a registered point or a home point by a user at each time. Thus, information on a user's home point and information on a registered point are associated and stored in the in-vehicle device information DB 12b of the map data distribution server 1.

Thereafter, it is assumed that a new version of map data is additionally stored in the map DB 12a of the map data distribution server 1. Specifically, a new version of map data may be, for example, created by another apparatus and obtained from the apparatus via communications, and thus additionally stored in the map DB 12a. Alternatively, map data stored in a storage medium may be copied to the map DB 12a.

At step 220, the control unit 13 performs an updating data extraction and a distribution operation based on a new version of map data stored in the map DB 25a.

The updating data extraction and the distribution operation is performed for extracting data needed for a user of the in-vehicle navigation device 2 from a latest version of map data and for distributing extracted data to the in-vehicle navigation device 2.

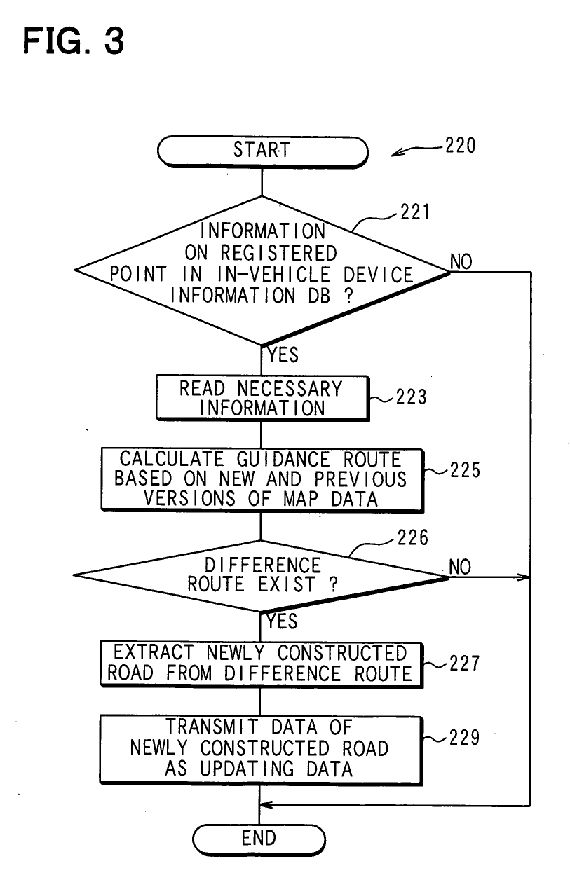

FIG. 3 is a flow chart showing the updating data extraction and the distribution operation in detail. At step 221, the control unit 13 first tries to read information on a home point and information on a registered point associated with the user from the in-vehicle device information DB 12b. When the information is stored and when the control unit 13 succeeds in the reading, the processing proceeds to step 223. Alternatively, when the information is not stored, the control unit 13 terminates the updating data extraction and the distribution operation.

At step 223, from the storage medium 12, the control unit 13 reads data needed for subsequent processing. Specifically, the control unit 13 reads position information on a user's home point, position information on a user's registered point, map data of the same version as a version of map data currently stored as user's information, and a new version of map data.

At step 225, the control unit 13 calculates a guidance route from a home point to a registered point based on the new version of map data using read information on a user's home point and information on a registered point. Further, the control unit 13 reads a version (previous version) of map data currently stored as user's information. Thus, the control unit 13 calculates a guidance route from the home point to the registered point based on the same version of map data as the previous version of map data. The same algorithms and search conditions are used for calculation of the guidance route in both of the cases.

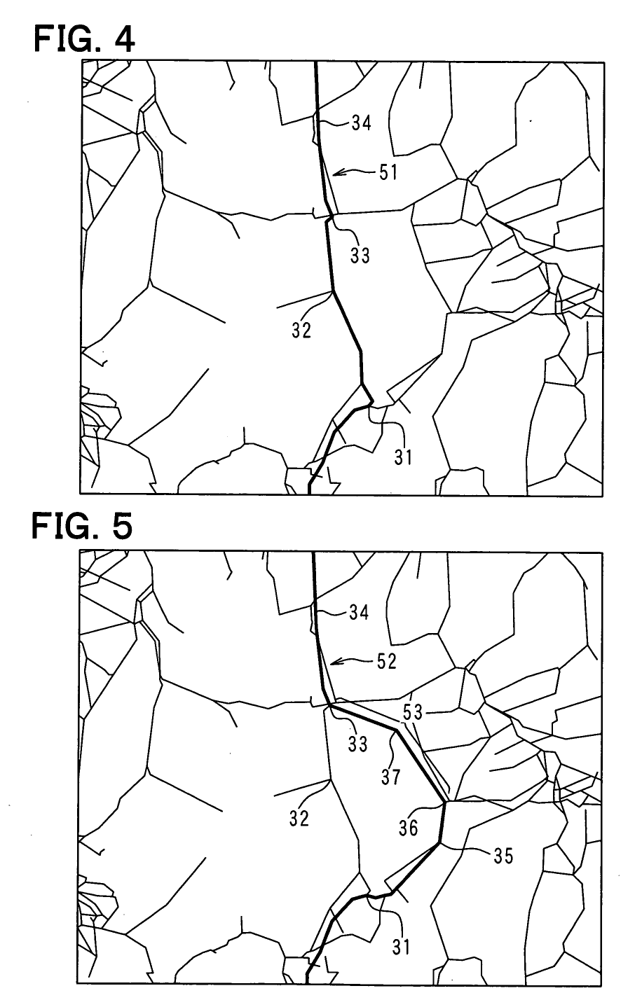

FIG. 4 shows one example 51 of a guidance route calculated by using the previous version of map data. FIG. 5 shows another example 52 of a guidance route calculated by using the new version of map data for the same home point and registered point shown in FIG. 4. In the present examples, a highway 53, which is not stored in the previous version of map, is additionally stored in the new version of map.

At step 226, it is determined whether a difference route exists by comparing the calculated guidance routes. Specifically, it is determined whether at least one difference route exists between the guidance route calculated based on the new version of map data and the guidance route calculated based on the previous version of map data. More specifically, the guidance route calculated based on the new version of map data passes along the at least one difference, and the guidance route calculated based on the previous version of map data does not pass along the at least one difference route. When at least one difference route exists, the processing proceeds to step 227. Alternatively, when at least one difference route does not exist, the updating data extraction and distribution operation is terminated.

In the examples of FIG. 4 and FIG. 5, the guidance route 51 calculated based on the previous version of map data passes through points 31, 32, 33, 34, and the guidance route 52 calculated based on the new version of map data passes through points 31, 35, 36, 37, 33, 34. In this case, the difference route starts from the point 31, passes through the points 35, 36, 37, and reaches the point 33.

Alternatively, multiple registered points may be stored in the in-vehicle device information DB 12b of a user. In this case, at step 223, the control unit 13 calculates a guidance route from a home point to each of the multiple registered points for each of both the previous version of map data and new version of map data. At step 226, the control unit 13 extracts a difference route by comparing a guidance route from a home point to a registered point of the previous version of map data and a guidance route from a home point to the same registered point of the new version of map data.

At step 227, all new additional roads (newly constructed roads) are extracted from the difference route. The new additional road is stored in the new version of map data and is not stored in the previous version of map data. It is determined whether a link of a difference route is a new additional road in accordance with determination whether the link is stored in the previous version of map data.

In the examples of FIGS. 4, 5, a range of a newly constructed highway 53 is extracted as a new additional road from a difference route specified by the points 31, 35, 36, 37, 33.

At step 229, only data of the new additional road is extracted from the road data of the new version of map data. Thus, the communication interface 11 is caused to transmit the extracted data to the in-vehicle navigation device 2 as updating data. The updating data further includes information on the version of new version of map data.

The control unit 26 receives the updating data transmitted via the communication interface 24. At step 230 (FIG. 2), the control unit 26 updates the map data and performs notice of completion.

Specifically, the control unit 26 adds the road data of the updating data to the previous version of map data, which is currently stored in the map DB 25a. Subsequently, the control unit 26 rewrites the version information on the map data after the addition of the road data to the version information on the updating data. Thus, only the portion of the map data of the map DB 25a is updated in accordance with necessity of a user, and the version information on the map data is also updated to the version information on the new version.

As described above, all the road data of the updating data may be added to the map data of the map DB 25a. Alternatively, all the road data of the updating data may be displayed on the display device 22, and a user may determine road data to be added by instructing links of the road data using the operation portion 23.

Subsequent to the updating of the map data, the control unit 26 transmits notice of completion of the updating to the map data distribution server 1 via the communication interface 24. The control unit 13 receives the notice of completion via the communication interface 11, and thereby overwrites the version information on the new version of map data as the version information on the user's map data in the point information DB 25b. That is, the version of the user's map data stored by a control unit 26b is replaced with the new version. Thus, useless transmission of the road data of the same version to the in-vehicle navigation device 2 can be avoided.

As described above, the map data distribution server 1 extracts updating data by using information on a point such as a home point and a registered point set in the in-vehicle navigation device 2 in a map distribution operation. In the present structure, the map data distribution server 1 handles point information registered by a user in the in-vehicle navigation device 2. When a new version of map data is added to the map data distribution server 1 and when the map data distribution server 1 searches a guidance route from a home point to a registered point including an additional new additional road, the map data distribution server 1 extracts updating data corresponding to the new additional road and distributes to the in-vehicle navigation device 2. Thus, the in-vehicle navigation device 2 receives the updating data and updates map data.

More specifically, from the storage medium 12 (step 223), the map data distribution server 1 reads:

position information on a home point registered as a home of a user, who receives distributed map data;

position information on a registered point, which is associated with a user or the in-vehicle navigation device 2 of a user and registered;

a previous version of map data, which is the same version as user's map data; and

a new version of map data, which is newer than the previous version of map data. Further, based on the new version of map data, the map data distribution server 1 calculates a new route from the home point to the registered point (step 225). Further, the map data distribution server 1 extracts a new additional road, which is specified in the new version of map data and is not specified in the previous version of map data, from the new route (step 227). Further, the map data distribution server 1 extracts road data of the extracted new additional road from the new version of map data. Further, the map data distribution server 1 transmits the extracted road data to the in-vehicle navigation device 2 (step 229).

In the present structure, new road data of a road, which passes from a user's home point through a new route to a registered point associated with the user's home point, is selectively distributed from the map data distribution server 1 to the in-vehicle navigation device 2. Therefore, distribution of a portion of map data, which need not be updated for a user of the map data distribution server 1, can be reduced.

In addition, if necessary, data of a road, which the in-vehicle navigation device 2 has not passed in the past, can be distributed to the in-vehicle navigation device 2.

Further, the map data distribution server 1:

calculates a previous route from the home point to the registered point using the previous version of map data (step 225);

extracts a difference route, which is in the new route and is not in the previous route (step 226); and

extracts a new additional road, which is specified in the new version of map data and is not specified in the previous version of map data, from the difference route (step 227).

Further, the map data distribution server 1: compares the previous route calculated using the previous version of map data with the new route calculated using the new version of map data; extracts a route only in the new route as a difference route, which may include a new additional road; and extracts a new additional road from the difference route. In this way, operation load for extracting the new additional road can be reduced compared with a case where a new additional road is extracted from an entire new route. Specifically, when a new additional road is extracted from an entire new route, it is necessary to determine whether all the links of a new route exists in a previous version of map data. On the contrary, when a newly constructed is extracted from a difference route, it suffices to determine whether only links of a difference route exists in a previous version of map data.

### Other Embodiment

In the above description, the map data distribution server 1: calculates a previous route from the home point to the registered point using the previous version of map data (step 225); extracts a difference route, which is in the new route and is not in the previous route (step 226); and extracts a new additional road, which is specified in the new version of map data and is not specified in the previous version of map data, from the difference route (step 227). Alternatively, the map data distribution server 1 may extract a new additional road from an entire new route. In this case, it is not necessary to extract a difference route, and therefore, it is not necessary to calculate a previous route.

Further, at step 225, in calculation of a guidance route from the home point to the registered point, the map data distribution server 1 may calculate a guidance route from the home point to the registered point using multiple guidance route calculation algorithms, which can be used by the in-vehicle navigation device 2, for each of the previous version of map data and a new version of map data.

Alternatively, a user of the in-vehicle navigation device 2 may set a default value for an algorithm using the control unit 13 and transmit the algorithm to the map data distribution server 1. In this case, at step 225, the map data distribution server 1 may calculate a guidance route based on the previous version of map data and the new version of map data using the algorithm.

When a guidance route is calculated using the multiple algorithms, at step 226, the control unit 13 compares a guidance route calculated based on the previous version of map data using an algorithm with a guidance route calculated based on the new version map data using the same algorithm. Thus, the control unit 13 extracts a difference route from the guidance routes. The algorithm for calculation of a guidance route may be, for example, an algorithm with a distance priority, an algorithm with a toll road priority, an algorithm with a local street priority, and the like.

Alternatively, a user may connect, not the in-vehicle navigation device 2, but a personal computer with the map data distribution server 1 via a wide area network. In this case, the user may specify an algorithm used at step 225 through the connection. Alternatively, a user may access a portal site (Web site) of the Internet using a Web browser installed in a personal computer. In this case, the user may specify an algorithm in the portal site and may cause a server of the portal site to transmit the specified algorithm and identification information on the user or identification information on the in-vehicle navigation device 2 to the map data distribution server 1. In this case, at step 225, the map data distribution server 1 may calculate a guidance route using the algorithm transmitted from the server of the portal site when a user is a target of distribution.

At step 229, in addition to the road data of the new additional road, data of a facility along the new additional road may be extracted from the facility data of the new version of map data and may be included in the updating data. Thus, the updating data may be transmitted to the in-vehicle navigation device 2.

Distribution of updating data from the map data distribution server 1 to the in-vehicle navigation device 2 is not limited to the method described in the embodiment. It suffices that the map data distribution server 1 transmits updating data such that the in-vehicle navigation device 2 can finally receive the updating data via a certain route and can use the updating data.

For example, a user may cause a personal computer to connect with a wide area network so as to communicate with the map data distribution server 1. In this case, the user may cause the personal computer to download updating data through the connection and may cause the personal computer to store the downloaded updating data in a portable storage medium, such as a USB memory. Thereafter, the user may connect the portable storage medium with the map data distribution server 1 and copy the updating data in the portable storage medium to the storage medium 25 of the in-vehicle navigation device 2.

In the embodiment, the in-vehicle navigation device 2 is employed as an example of a target of map data distribution. Alternatively, the target of map data distribution may be an in-vehicle map display device or another in-vehicle device. Further alternatively, the target of map data distribution may be a mobile navigation device or a mobile map display device, which can be carried by a user. Namely, the target of map data distribution may be a map using device, which is used by a user for indication, route guidance, and the like using distributed map.

Summarizing the embodiment, the map data distribution server for distributing map data includes:

a communication interface (13) configured to distribute map data;

a storage medium (12); and

a control unit (13).

From a storage medium (12), the control unit (13) is configured to read:

position information on a home point registered as a home of a user who receives distribution of map data;

position information on a registered point associated with the home point and registered;

first map data being the same as map data used by the user in version; and

second map data which is newer than the first map data in version.

The control unit (13) is configured to:

calculate a route (new route) from the home point to the registered point using the second map data;

extract a new additional road, which is specified in the second map data and not specified in the first map data, from the new route;

extract road data of the extracted new additional road from the second map data; and

transmit the extracted road data to a user's device.

In the present structure, new road data of a road, which passes from a user's home point through a new route to a registered point associated with a user or a user's device, is selectively distributed from the map data distribution server 1 to the in-vehicle navigation device 2. Therefore, distribution of a portion of map data, which need not be updated, can be reduced.

The map data distribution server for distributing map data may be further configured to: calculate a route (previous route) from the home point to the registered point using the first map data; extract a difference route, which does not overlap the previous route, from the new route; and extract a new additional road, which is specified in the second map data and not specified in the first map data, from the difference route.

The map data distribution server 1 is configured to: compare the previous route calculated using the previous version of map data (first map data) with the new route calculated using the new version of map data (second map data); extract a route only in the new route as a difference route, which may include a new additional road; and extract a new additional road from the difference route. In this way, operation load for extracting the new additional road can be reduced compared with a case where a new additional road is extracted from entire new route.

The above structures of the embodiments can be combined as appropriate.

The above processings such as calculations and determinations are not limited being executed by the control unit 13. The control unit may have various structures including the control unit 13 shown as an example.

The above processings such as calculations and determinations may be performed by any one or any combinations of software, an electric circuit, a mechanical device, and the like. The software may be stored in a storage medium, and may be transmitted via a transmission device such as a network device. The electric circuit may be an integrated circuit, and may be a discrete circuit such as a hardware logic configured with electric or electronic elements or the like. The elements producing the above processings may be discrete elements and may be partially or entirely integrated.

It should be appreciated that while the processes of the embodiments of the present invention have been described herein as including a specific sequence of steps, further alternative embodiments including various other sequences of these steps and/or additional steps not disclosed herein are intended to be within the steps of the present invention.

Various modifications and alternations may be diversely made to the above embodiments without departing from the spirit of the present invention.

What is claimed is:

1. A map data distribution server for distributing map data, the map data distribution server comprising:
a communication interface configured to distribute map data;
a storage medium; and
a control unit,
wherein the control unit includes:
a reading unit configured to read from the storage medium that:
i) position information on a home point registered as a point of a home of a user who is to receive distributed map data;
ii) position information on a registered point associated with the user or a user's device used by the user and stored in the storage medium;
iii) first map data same as map data used by the user in version; and
iv) second map data newer than the first map data in version;
a route calculating unit configured to calculate a new route from the home point to the registered point based on the second map data;
a new additional road extracting unit configured to extract a new additional road, which is specified in the second map data and is not specified in the first map data, from the new route; and
a transmitting unit configured to extract road data of the extracted new additional road from the second map data and transmit the extracted road data to be used by the user's device.

2. The map data distribution server according to claim 1,
wherein the route calculating means is further configured to calculate a previous route from the home point to the registered point based on the first map data,
the map data distribution server further comprising:
a difference route extracting unit configured to extract a difference route, which does not overlap the previous route, from the new route, and
the new additional road extracting unit is configured to extract a new additional road, which is specified in the second map data and is not specified in the first map data, from the difference route.

3. A method for processing map data to be distributed to a user, the method comprising:
reading from a storage medium in a map data distribution server that:
i) position information on a home point registered as a point of a home of the user;
ii) position information on a registered point associated with the user or a user's device;
iii) first map data same as map data used by the user in version; and
iv) second map data newer than the first map data in version;
calculating a new route from the home point to the registered point based on the second map data;
first extracting a new additional road, which is specified in the second map data and is not specified in the first map data, from the calculated new route; and
second extracting road data of the extracted new additional road from the second map data.

4. The method according to claim 3, further comprising:
calculating a previous route from the home point to the registered point based on the first map data;
third extracting a difference route, which does not overlap the previous route, from the new route,
wherein the first extracting further includes:
fourth extracting a new additional road, which is specified in the second map data and is not specified in the first map data, from the difference route.
